(19) United States
(12) Patent Application Publication
(10) Pub. No.: US 2006/0246971 A1
(43) Pub. Date: Nov. 2, 2006

(54) Electronic basketball assistant that provides virtual competition

(76) Inventor: Chatman Ellis, Mobile, AL (US)

Correspondence Address: BRADLEY ARANT ROSE & WHITE LLP, 200 CLINTON AVE. WEST, SUITE 900, HUNTSVILLE, AL, 35801, US

(21) Appl. No.: 11/094,567

(22) Filed: Mar. 30, 2005

(51) Int. Cl. A63F 13/00

(52) U.S. Cl. 463/4

(57) ABSTRACT

An apparatus for providing virtual competition in a basketball game has been developed. The apparatus includes an electronic processor that simulates the performance of a virtual player in a basketball game. The apparatus also includes a data interface that allows the communication of the performance of the physical player to the electronic processor so that the results of the basketball game can be determined by the physical player.

### BACKGROUND OF INVENTION

1. Field of the Invention

The invention relates generally to electronic games. More specifically, the invention relates to an electronic basketball assistant that can replace a competitor in certain basketball games.

2. Background Art

Basketball is a common and popular game for people of all ages. The popularity of basketball has given rise to many variations of the standard full court game of two teams of five players. Since basketball only requires minimal equipment of a goal and a basketball, variations on the game are usually determined by the number of players present. For example, some games are playable by an odd number of players who could not be divided evenly into separate teams. Instead of direct competition, many of these variants offer competition to make a variety of shots.

However, these games typically require more than one person to play. A solitary version of these games would be advantageous for play when a competitor is not available. Consequently, it would be advantageous to have an electronic device that simulates the play of an opponent in a variant basketball game.

### SUMMARY OF INVENTION

In some aspects, the invention relates to an apparatus for simulating play of a player in a basketball game, comprising: an electronic processor that simulates the performance of a virtual player in a basketball game; and a data interface that allows the communication of the performance of a physical player to the electronic processor so that the results of the basketball game can be determined.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a detailed view of an electronic basketball assistant in accordance with one embodiment of the present invention.

FIG. 2 shows a view of a wrist mounted electronic basketball assistant in accordance with one embodiment of the present invention.

### DETAILED DESCRIPTION

An electronic basketball assistant has been developed. The invention simulates the actual performance of a competitor for a variant basketball game. It serves as a substitute or “virtual” player so that a single person can play an actual physical game against an electronic opponent. Examples of variant basketball games suitable for play with the invention include: “Horse”; “Pig”; and “Around the World”. These types of games are defined as “shooting games” in that they are a competition of shot making skills among the participants as opposed to a traditional basketball team game.

For example, a game of Horse may be played with two players. One player who goes first is “in control”. The player makes a shot attempt from any place of his choosing. Additionally, the player may attempt a shot in any fashion such as a “lay-up”, a “sky-hook”, or any other sort of variations. If the player in control misses the shot, control passes to the second player who may then attempt to make a shot from any place and in any style of his choosing. However, if the player in control makes his shot, the second player now must duplicate that shot. If the second player duplicates that shot, the in control player attempts another shot from any place and in any style he chooses. However, if the second player misses the shot, he has a letter added to his “score”. In this example, the letter “H” would be added. The in control player attempts another shot from any place and in any style he chooses. The process repeats itself until one of the players has all of the letters of “HORSE” as his score. At this point, this player loses the game. A shorter variant of the game is “Pig” that is played the same way except that the first player to spell “PIG” loses.

Another example of a shooting game is “Around the World”. In this game nine distinct shooting locations are arranged in an arc around the basketball goal. The first player attempts to make a shot from position number one. If he makes the shot, he advances to position number two. If he fails to make the shot at position number one, he may “stay” and wait until the second player turn or “chance”. If the player chooses “chance” he attempts the same shot again. If he makes it, he proceeds to the next position. If he misses, he returns to the beginning (in this case position number one) and the second player takes his turn. In some versions of the game, a miss at starting position one may not be “chanced”. The players continue the game until one player has successfully shot at all positions. This player is considered the winner because he has gone “around the world”.

It should be clear that many such shooting games can use variable numbers of players, rules, etc. As such, it should also be clear that such variations are intended to be covered with the scope of the present invention.

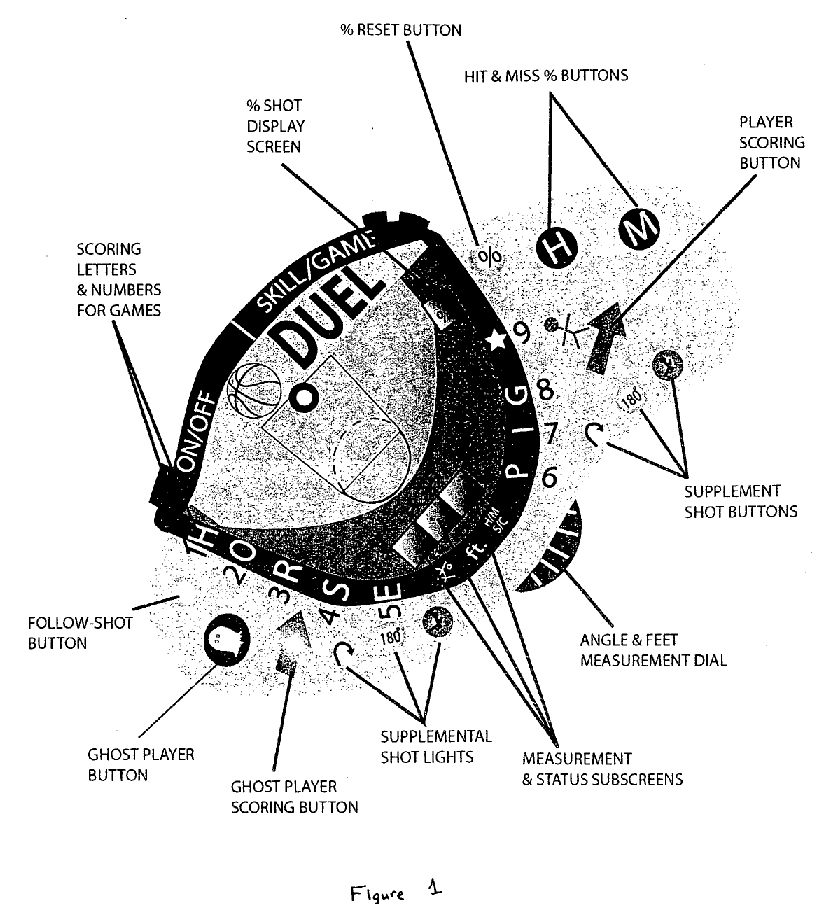

FIG. 1 shows a detailed view of an electronic basketball assistant in accordance with one embodiment of the present invention. This embodiment of the invention is designed to assist in the play of the games of “Horse”, “Pig” or “Around the World”. The assistant provides the simulated results for a virtual or “ghost” player against whom the user can simulate playing a game. The simulated results are generated by an electronic microprocessor within the assistant. The performance of the ghost player and the physical player are entered and shown on the display screen of the assistant.

The features of the assistant include an on/off button, a skill level button, and a game selection button. In this embodiment, there are three skill levels: beginner, intermediate (default level), and advanced. The skill level determines the following characteristics of the ghost player: hit/miss percentage; angle to the goal; and distance to the goal. Other characteristics include shot type (lay-up, sky-hook, turn-around jump shot, etc.). The game selection button in this embodiment allows selection between the games of “Horse” (default), “Pig”, and “Around the World”.

The ghost player button is used to activate the ghost player. In the game of Horse or Pig, the ghost player has free reign to shoot from any location on the screen court. Additionally, the ghost player may increase the shot difficultly by attempting a lay-up, a 180° turn around jump shot, or a hook shot as indicated by the supplemental shot lights. If the lay-up shot light is lit, the display will indicate from which side of the goal the lay-up was attempted. The display also shows a viewing of the shot and indicates whether it is successful on a status subscreen. In the game of Around the World, the nine positions are marked around the goal. The ghost player's shots are viewed and his position is indicated on the display. Whether the shot is a hit/miss and whether the ghost player chooses to stay/chance is indicated on a status subscreen.

In this embodiment, there a three separate subscreens that display information about the ghost player. They also allow information to be input regarding the performance of the user. One subscreen displays the angle of the shot. In this example, a 0° angle indicates a shot along the baseline while a 90° angle indicates a shot along the center of the free throw line. The distance subscreen displays the distance from the goal. This distance is displayed in arcs emanating from the goal in 2 ft. increments. With a combination of these two screens, a shot from anywhere on the court can be displayed. The third subscreen indicates the success of a shot (H/M) or the decision to stay/chance (S/C) in Around the World.

In an example of operation of the present invention, the player will attempt a shot if they are in control. If the shot is made, it is necessary to tell the ghost player the details of the shot. This is done with the rotating dial that enters the angle and feet measurement of the shot. When the correct distance and angle is displayed on the appropriate subscreen, the data is entered by pressing the follow shot button. Then, the ghost player button is pressed and the ghost player attempts a shot. If the ghost player is successful, the player attempts another shot. If the ghost player is unsuccessful, the ghost player scoring button is pressed and the ghost player's current score (represented by the appropriate letters of the game) is updated. When the ghost player is in control and makes his shot and the player misses his shot, the player scoring button is pressed to update the player's current score (represented by the appropriate letters of the game). In a game of Around the World, the player's and ghost player's respective positions are indicated by displays opposite the numerals around the display.

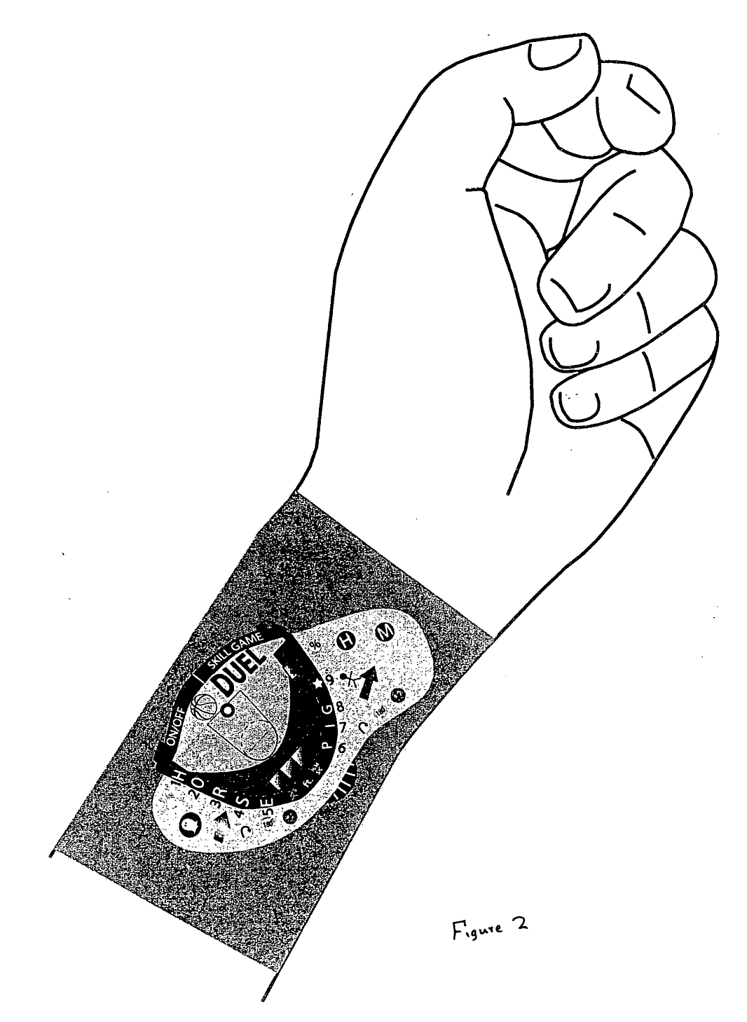

Other features of the present invention include a shot percentage tracker. This may be used by the player to keep track of their overall accuracy. The current percentage of shots made is shown on the display screen. A button is also present to reset the shot percentage as desired. In other embodiments, the present invention may be attached to a wrist band as shown in FIG. 2. This makes the use of the assistant more convenient while playing. Other embodiments could include the use of multiple ghost players or multiple real players. Additionally, it should be understood that the present invention could be modified to simulate a competitor in other types of games such as golf, baseball, etc.

Additionally, the electronic basketball assistant may have an electronic memory capacity. The memory may be used to store games, keep a record of player performance, etc. The memory capacity may be an electronic data storage device that is an integrated part of the assistant or it could be a separate device. The memory may able to download records of games or player performance from a computer, another electronic memory device, etc. Conversely, the assistant may be able to send records to these devices. In this manner, players may share games and compete against each other and the assistants. Also, certain games may be loaded from the memory device and played again.

It should be clear that other embodiments of the electronic basketball assistant may have a wide variety of features in many different configurations. While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. An apparatus for simulating play of a player in a basketball game, comprising:
an electronic processor that simulates the performance of a virtual player in a basketball game; and
a data interface that allows the communication of the performance of a physical player to the electronic processor so that the results of the basketball game can be determined.

2. The apparatus of claim 1, where the basketball game is a shooting game.

3. The apparatus of claim 2, where the shooting game is “Around the World”.

4. The apparatus of claim 2, where the shooting game is “Horse”.

5. The apparatus of claim 2, where the shooting game is “Pig”.

6. The apparatus of claim 1, where the processor simulates the performance of a virtual player at multiple skill levels.

7. The apparatus of claim 1, where the processor simulates the performance of multiple virtual players.

8. The apparatus of claim 1, further comprising:
an electronic memory storage device that stores data from the basketball game.
